(19) United States
(12) Patent Application Publication
(10) Pub. No.: US 2011/0169653 A1
(43) Pub. Date: Jul. 14, 2011

(54) PERSON-SUPPORT APPARATUS HEIGHT INDICATOR

(76) Inventors: Jack Xiao Peng Wang, Singapore (SG); Abel Boon Thong Ang, Singapore (SG); Steven A. Dixon, Cincinnati, OH (US)

(21) Appl. No.: 13/006,717

(22) Filed: Jan. 14, 2011

(30) Foreign Application Priority Data
Jan. 14, 2010 (SG) 201000280-6

(51) Int. Cl. G08B 21/00

(52) U.S. Cl. 340/686.6

(57) ABSTRACT

A person-support apparatus 10 comprises a lower frame, a support, an upper frame, and a light source. The support is coupled to the lower frame. The upper frame is movably supported above the lower frame by the support. The light source is configured to selectively emit light at one of a first wavelength and a second wavelength as a function of the height of the upper frame with respect to a reference point in order to indicate the height of the upper frame.

This application claims the benefit of Singapore Patent Application Serial No. 201000280-6, filed Jan. 14, 2010, which is hereby expressly incorporated by reference herein.

### BACKGROUND OF THE DISCLOSURE

The present disclosure relates generally to a person-support apparatus, such as, a hospital bed. More specifically, but not exclusively, one illustrative embodiment relates to an indicator configured to alert a patient and/or a caregiver as to the height of the bed with respect to the floor.

Person-support apparatuses utilized in healthcare facilities can include many features, such as, for example, lifting mechanisms configured to raise and lower the upper frame of the person-support apparatus with respect to the lower frame. Some occupants supported on the person-support apparatus and/or caregivers may wish to know the height of the upper frame with respect to the floor. While various person-support apparatuses have been developed, there is still room for development. Thus a need persists for further contributions in this area of technology.

### SUMMARY OF THE DISCLOSURE

The present disclosure includes one or more of the features recited in the appended claims and/or the following features which, alone or in any combination, may comprise patentable subject matter.

One illustrative embodiment of the present disclosure can include a height indicating system coupled to a person-support apparatus and configured to emit light at a first wavelength when the upper frame is less than or equal to a predetermined distance above the floor and emit light at a second wavelength when the upper frame is greater than a predetermined distance above the floor.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

Referring now to the illustrative examples in the drawings, wherein like numerals represent the same or similar elements throughout:

FIG. 1 is a perspective side view of a person-support apparatus in a first position including a height indicating system configured to emit light at a first wavelength when the upper frame of the person-support apparatus is in a first position with respect to the lower frame of the person-support apparatus according to an embodiment of the current disclosure;

FIG. 2 is a perspective side view of person-support apparatus of FIG. 1 with the upper frame in a second position with respect to the lower frame, which causes the height indicating system to emit light at a second wavelength;

FIG. 3 is a diagrammatic view of the supports including a lift mechanism, lift driver, and lift control system according to one embodiment of the current disclosure;

FIG. 4 is a perspective front view of the height indicating system of the person-support apparatus of FIG. 1;

FIG. 5 is a perspective bottom view of the height indicating system of FIG. 1 with a portion of the housing cut away to show the inner chamber;

FIG. 6 is a perspective side view of the height indicating system of FIG. 1 showing the height indicators and the communication connectors; and

FIG. 7 is a diagrammatic view of the height indicating system of FIG. 1

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

One illustrative embodiment of the present disclosure can include a height indicating system coupled to a person-support apparatus and configured to emit light at a first wavelength when the upper frame is less than or equal to a predetermined distance above the floor and emit light at a second wavelength when the upper frame is greater than a predetermined distance above the floor.

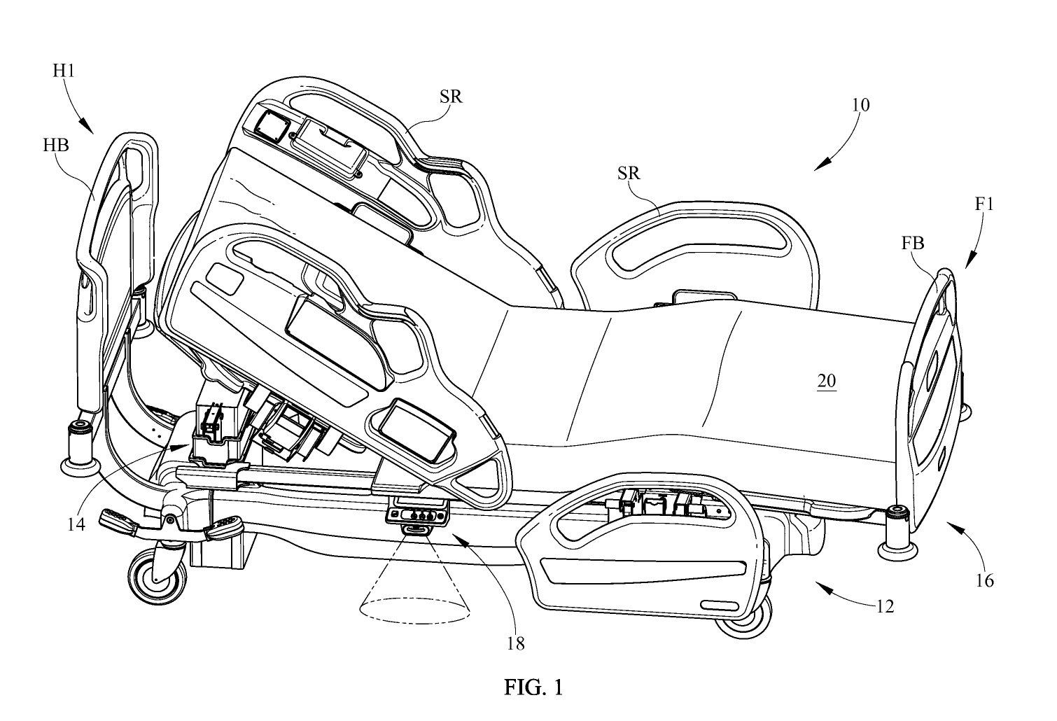

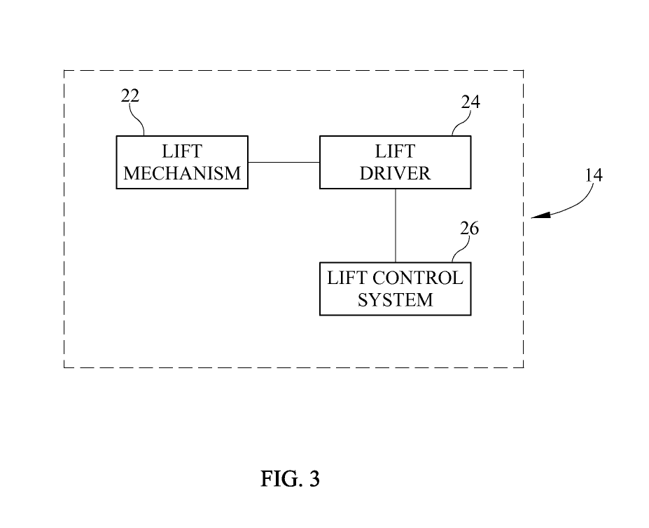

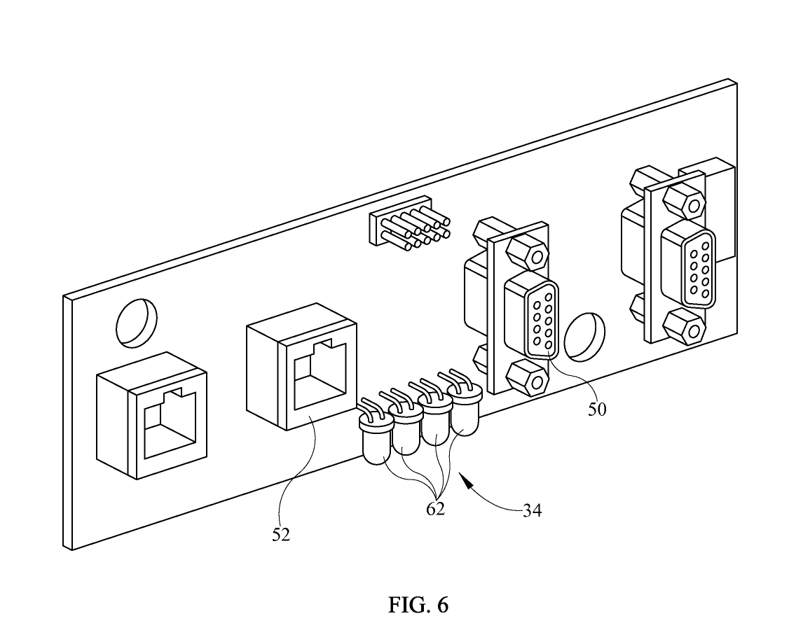

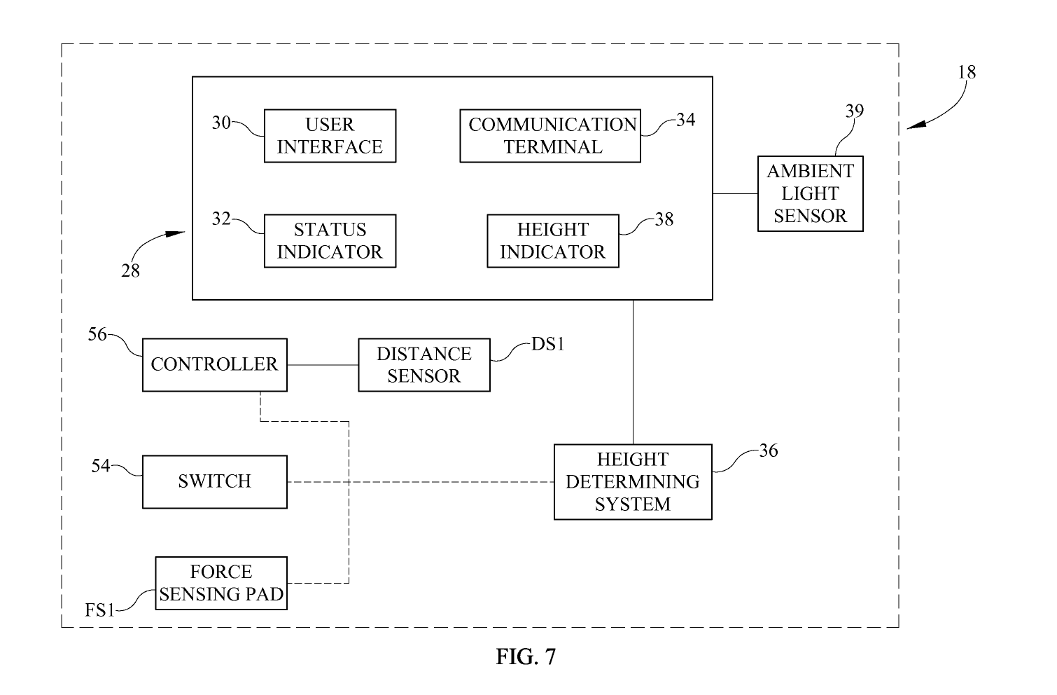

A person-support apparatus 10 according to one illustrative embodiment of the current disclosure is shown in FIGS. 1-7. In one illustrative embodiment, the person-support apparatus 10 can be a hospital bed and can include a head support section H1 or a first section H1, where the head of a person (not shown) can be positioned and a foot support section F1 or a second section F1, where the feet of the person (not shown) can be positioned. It should be appreciated that the person-support apparatus 10 can also be a hospital stretcher or an operating table.

The person-support apparatus 10 can include a lower frame 12 or base 12, a plurality of supports 14 coupled with the lower frame 12, an upper frame 16 supported on the supports 14 above the lower frame 12, and a height indicating system 18. It should be appreciated that the person-support apparatus 10 can include only one support 14. In one illustrative embodiment, the person-support apparatus 10 can support a person-support surface 20 or mattress 20 on the upper frame 16. The lower frame 12 can include one or more sections and can couple with the plurality of supports 14 to support the upper frame 16. The upper frame 16 can include siderails SR, a headboard HB, and a footboard FB coupled thereto.

The plurality of supports 14 can be coupled to the lower frame 12 and the upper frame 16 and can be configured to move the upper frame 16 from a first position with respect to the lower frame 12 to a second position with respect to the lower frame 12. The plurality of supports 14 can include a lift mechanism 22, a lift driver 24, and a lift control system 26 configured to control the lift driver 24. The lift driver 24 can be coupled to the lift mechanism 22 and at least one of the upper frame 16 and lower frame 12 and can be configured to cause the lift mechanisms 22 to expand, contract, rotate, pivot and/or slide to raise, lower, and/or tilt the upper frame 16 with respect to the lower frame 12. In one illustrative embodiment, the lift driver 24 can be a linear actuator 24 and the lift mechanism 22 can be a parallelogram linkage 22. It should be appreciated that the plurality of supports 14 can be or can include at least one of telescoping towers, scissor lifts, rotational lifts, hydraulic lifts or actuators, pneumatic lifts or actuators, linear actuators, electronic actuators, chain lifts, or other lift mechanisms. It should further be appreciated that the plurality of supports 14 can include a fixed column (not shown).

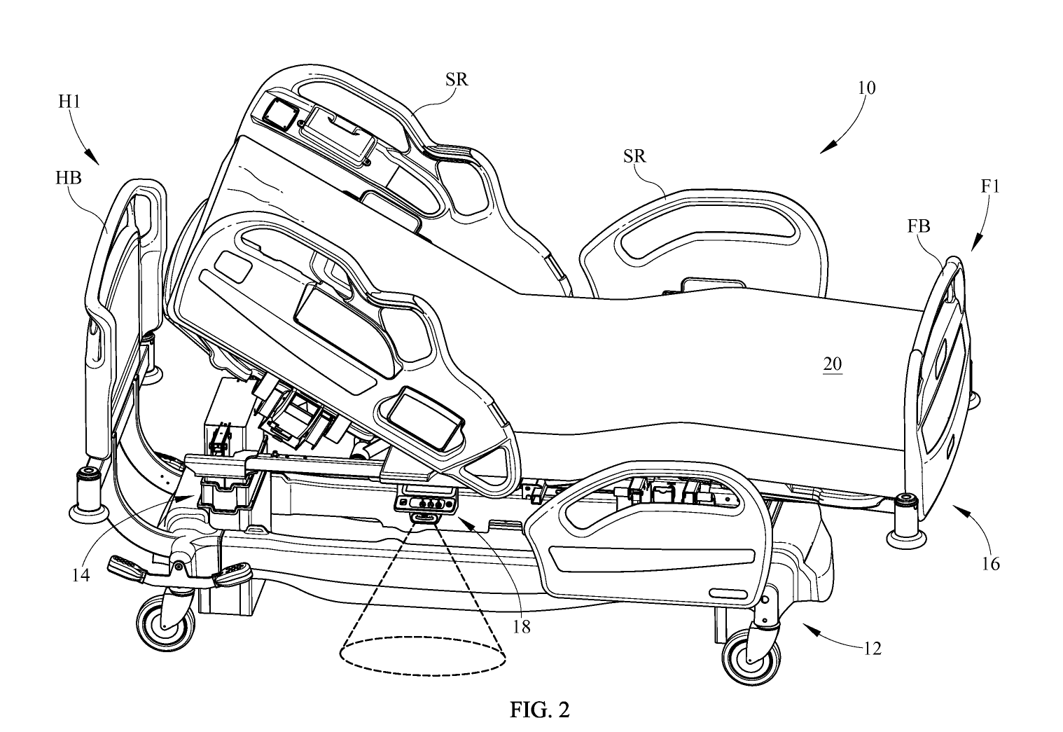

The height indicating system 18 can be configured to indicate the height of the upper frame 16 above a floor that the person-support apparatus 10 is supported on. In one illustrative embodiment, the height indicating system 18 can be coupled to the upper frame 16 as shown in FIGS. 1-2. It should be appreciated that the height indicating system 18 can be coupled to the upper frame 16 with a fastener (not shown). In another illustrative embodiment, the height indicating system 18 can be coupled to an egress bar (not shown) that can be coupled to the person-support apparatus 10 and configured to help an occupant ingress/egress from the person-support apparatus 10. In other illustrative embodiments, the height indicating system 18 can be coupled to the siderail SR, the headboard HB, the footboard FB, the supports 14, the lower frame 12, a removable user interface (not shown), a pendant (not shown), and/or other portions of the person-support apparatus 10.

The height indicating system 18 can include a housing 28, a user interface 30, a status indicator 32, at least one communication terminal 34, a height determining system 36, and at least one height indicator 38. It should be appreciated that the height indicating system 18 can include an ambient light sensor 39 that can be configured to deactivate the height indicator 38 when the ambient light in the room is above a predetermined light threshold, and activate the height indicator 38 when the ambient light in the room is below a predetermined light threshold.

The housing 28 can include a front cover 40 and a rear cover 42. The front cover 40 can be removably coupled to the rear cover 42 and can cooperate with the rear cover 42 to define an inner chamber 44 therebetween. The rear cover 42 can include openings 46 therein that can be configured to provide access to the communication terminals 34 positioned within the inner chamber 44. In one illustrative embodiment, the user interface 30 and the status indicator 32 can be located on the front cover 40.

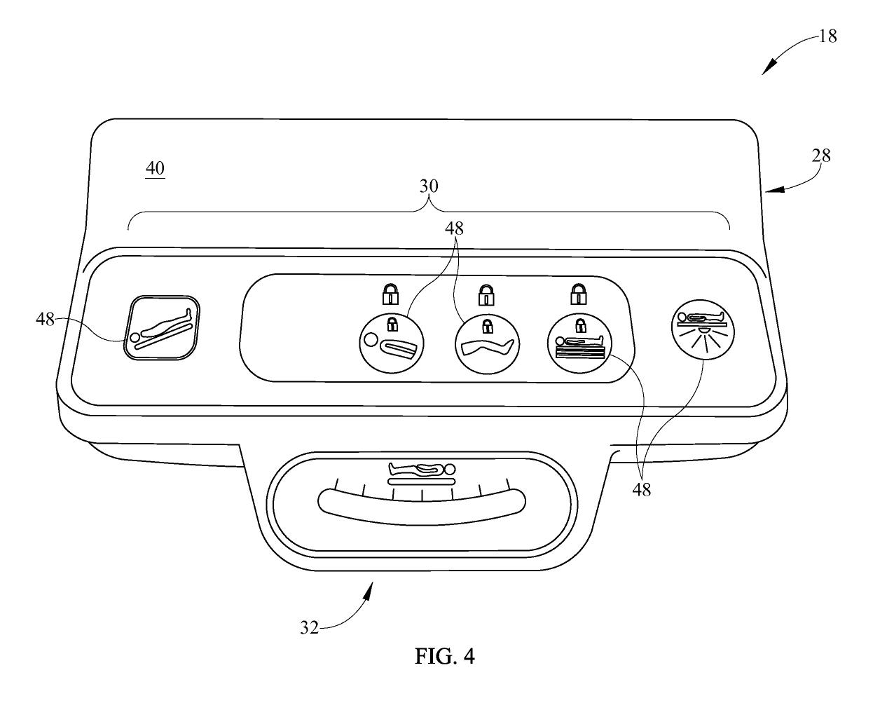

The user interface 30 can include buttons 48 and can be configured to receive an input from an occupant and/or caregiver to at least one of activate/deactivate the height indicator 28 and control at least one function of the person-support apparatus 10 as shown in FIG. 4. It should be appreciated that the user interface 30 can be configured to only activate/deactivate the height indicator 28. It should also be appreciated that the user interface can be a touch screen (not shown). It should also be appreciated that the user interface 30 can be voice activated. In one illustrative embodiment the user interface 30 can be configured to lock-out functions of the person-support apparatus 10. In another illustrative embodiment, the user interface 30 can be configured to cause the upper frame 16 to move to a Trendelenburg and/or reverse Trendelenburg position.

The status indicator 32 can be configured to indicate at least one of a status of the person-support apparatus 10, a status of a device connected to the person-support apparatus 10, and a status of the occupant on the person-support apparatus 10. In one illustrative embodiment, the status indicator 32 can be an inclinometer configured to indicate the angle of inclination of the head support section H1 with respect to horizontal as shown in FIG. 4. It should be appreciated that the status indicator 32 can be a display screen (not shown). It should also be appreciated that the user interface 30 and the status indicator 32 can be combined in a display (not shown), such as, for example, a touch-screen display. In another illustrative embodiment, the status indicator 32 can indicate whether the siderails SR are in a deployed position or a stowed position (up or down).

The communication terminals 34 can be configured to facilitate communication between the height indicating system 18 and other systems on the person-support apparatus 10. In one illustrative embodiment, the communication terminals 34 can facilitate communication between multiple height indicating systems 18 coupled to the person-support apparatus 10. In another illustrative embodiment, the communication terminals 34 can facilitate communication between the height indicator 38 and the height determining system 36. In yet another illustrative embodiment, the communication terminals 34 can facilitate communication between the height indicating system 18 and a control system (not shown) of the person-support apparatus 10. In still other illustrative embodiments, the communication terminals 34 can facilitate communication between the height indicating system 18 and a hospital network (not shown) or external device (not shown). The communication terminals 34 can include Serial Peripheral Interfaces (SPI) 50 and fiber optic interfaces 52. It should be appreciated that the communication terminals 34 can include Universal Serial Bus (USB) interfaces, Parallel Peripheral Interfaces, TCP/IP interfaces, or other communication interfaces. It should also be appreciated that the communication terminals 34 can be configured to facilitate wireless communication.

The height determining system 36 can be configured to determine the distance between the upper frame 16 and the floor. One way the height determining system 36 can determine the distance between the upper frame 16 and the floor is by using a switch 54. The switch 54 can be configured to close when the upper frame 16 is at a predetermined height with respect to the floor and remain open when the upper frame 16 is above the predetermined height. In one illustrative embodiment, the predetermined height can be an egress height. The switch 54 can be configured to cause the height indicator 38 to emit green light when the switch 54 is closed, and emit amber light when the switch 54 is open.

In one illustrative embodiment, the switch 54 can be a limit switch 54 that can be coupled directly to the height indicator 38 and to at least one of the lift driver 24 and the lift mechanism 22. It should be appreciated that more than one limit switch 54 can be used to indicate multiple positions of the upper frame 16, for example, a first limit switch 54 can be configured to indicate when the lift mechanism 24 and lift driver 24 have positioned the upper frame 16 in a first position, such as, for example, the lowest position with respect to the floor or a predetermined egress height, and a second limit switch 54 can be configured to indicate when the lift mechanism 24 and lift driver 24 have positioned the upper frame 16 in a second position, such as, for example, the highest position with respect to the floor.

In another illustrative embodiment, the switch 54 can be coupled to a controller 56 and at least one of the lift driver 24 and the lift mechanism 22. The controller 56 can be configured to control the activation/deactivation and/or wavelength of the light emitted by the height indicator 38 based on the input from the switch 54. In one illustrative embodiment, the controller 56 can be integrated into the control system of the person-support apparatus 10. In still another illustrative embodiment, the controller 40 can be enclosed within the housing 28.

In yet another illustrative embodiment, the switch 54 can be coupled to a controller (not shown) in the lift control system 26 and at least one of the lift driver 24 and the lift mechanism 22. The controller can be configured to receive a signal from the switch 54 indicative of whether the switch 54 is closed (i.e., the upper frame 16 is in the low position or egress position) or open (i.e., the upper frame 16 is not in the low position or the egress position). In one illustrative embodiment, the controller can output a serial protocol signal to the height indicator 38, where at least one bit of the signal can be utilized by the height indicator 38 to change the output of the height indicator. It should be appreciated that the number of bits utilized by the height indicator 38 can correspond to the number of switches 54. It should also be appreciated that the bit can cause the height indicator 38 to output light at a different color, i.e., green or amber. It should also be appreciated that the control does not make any decisions on what color the light output by the height indicator 38 should be and instead simply reports out the status of the switch 54 to the height indicator 38.

Another way the height determining system 36 can determine the distance between the upper frame 16 and the floor is by using a controller 56 and a distance sensor DS1 configured to emit a signal toward the lower frame 12 (or floor) and measure the reflected signal. In one illustrative embodiment, the distance sensor DS1 can be an ultrasonic transceiver configured to emit an ultrasonic signal toward the lower frame 12 and measure the echo of the signal reflected off the lower frame 12 to determine the height. In another illustrative embodiment, the distance sensor DS1 can be a laser configured to emit a beam of light toward the lower frame 12 and measure the angle of the reflected light to determine the height. It should be appreciated that the signals from the distance sensor DS1 could be directed toward and reflected by the floor.

Yet another way the height determining system 36 can determine the distance between the upper frame 16 and the lower frame (floor) is by using a controller 56 and a distance sensor DS1 to measure the amount of actuation of the lift driver 24. In one illustrative embodiment, the distance sensor DS1 can be a potentiometer within the lift driver 24. In another illustrative embodiment, the potentiometer could be coupled to one or more articulating parts of the person-support apparatus 10, such as, for example, the lift mechanisms 22.

Still another way the height determining system 36 can determine the distance between the upper frame 16 and the lower frame (floor) is by using a force sensor FS1 to sense when an occupant's feet are on the floor. In one illustrative embodiment, the force sensor FS1 can be a force sensing pad FS1 on the floor that can be configured to sense when the feet of an occupant sitting on the edge of the upper frame 16 touch the pad FS1. The contact between the occupant's feet and the pad FS1 can cause the supports 14 to stop lowering the upper frame 16 with respect to the lower frame 12 and cause the height indicator 38.

In one illustrative embodiment, the upper frame 16 can be in a first position with respect to the lower frame 12 and can begin moving from the first position to a second position, such as, an egress height, when a person position monitoring (PPM) system (not shown) of the person-support apparatus 10 determines that the occupant is going to exit the person-support apparatus 10. It should be appreciated that the upper frame 16 can begin moving from the first position to the second position when the occupant indicates through a user interface (not shown) that the occupant is exiting the person support apparatus 10 and/or desires for the upper frame 16 to be lowered to a second position. The PPM system can be configured to determine the location of the occupant on the upper frame 16 by measuring the amount of force on various force sensors (not shown) incorporated in the upper frame. One such PPM system is discussed in U.S. Pat. No. 7,253,366 to Bhai, issued on Aug. 7, 2007 and is herein incorporated by reference. It should be appreciated that other PPM system can determine the location of the occupant based on a center of gravity calculation. See U.S. Pat. No. 5,276,432 to Travis, issued on Jan. 4, 1994.

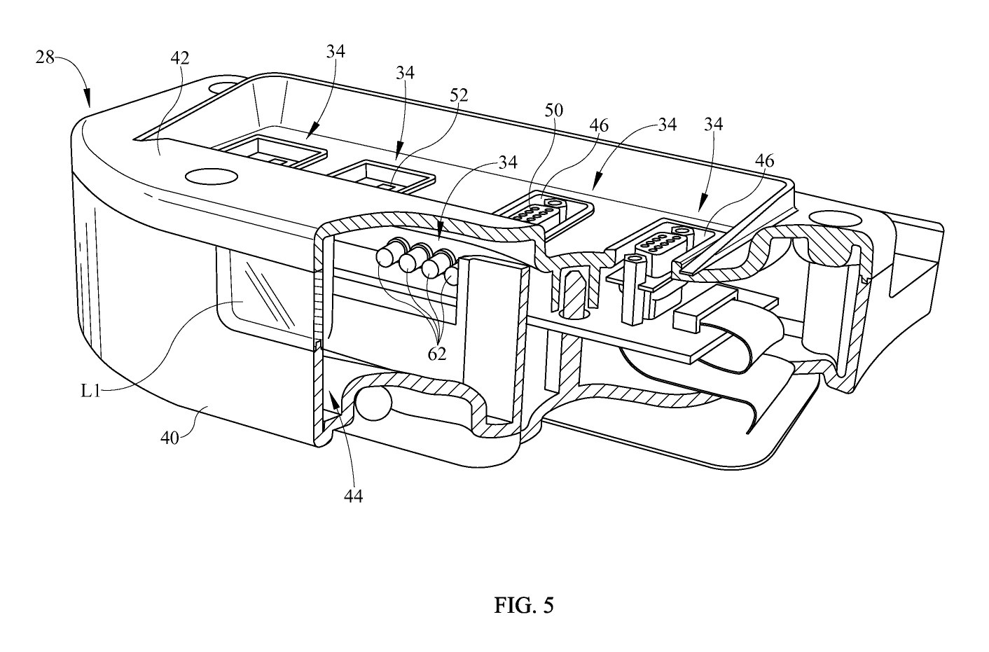

The height indicator 38 can be configure to indicate when the upper frame 16 is in a first position, which can correspond to the lowest the upper frame 16 can get with respect to the floor and/or can correspond to an egress height, with respect to the floor and when the upper frame 16 is in a second position, which can correspond to any height above the first position and/or above a predetermined position, with respect to the floor. In one illustrative embodiment, the height indicator 38 can include a plurality of lights 58. It should be appreciated that the height indicator 38 can be configured to indicate the height with sound generated by a sound generating device (not shown). It should also be appreciated that the height indicator 38 can indicate the height of the upper frame 16 above the lower frame 12 on a display (not shown). It should also be appreciated that the height indicator 38 can be combined with the status indicator 32 to display both the height of the upper frame 16 and another status of the person-support apparatus 10. The lights 58 can be directed toward the floor and configured to emit at least one wavelength of light as a function of a signal generated by the height determining system 36. It should be appreciated that emitting light toward the floor can be helpful to occupants during ingress/egress from the person-support apparatus 10 in low light conditions. It should also be appreciated that light can be emitted in directions other than toward the floor, such as toward the lower frame 12, side of the upper frame 16, away from the person-support apparatus, or other directions. It should also be appreciated that the lights 58 can also emit light through the status indicator 32. It should also be appreciated that the housing 28 can include an opening W1 in the base of the housing 28 with a lens L1 positioned therein that can be configured to disperse the light emitted by the lights 58 as shown in FIG. 5. In one illustrative embodiment, the lights 58 are controlled by the control 56. In another illustrative embodiment, the lights 58 are not controlled by the control 56.

The lights 58 can be configured to emit light at a first wavelength when the upper frame 16 is in a first position and emit light at a second wavelength when the upper frame 16 is in a second position. In one illustrative embodiment, the first wavelength of light emitted can be green (about 495-570 nm and/or about 526 THz) and the second wavelength of light can be amber (about 588 nm and/or about 510 THz). It should be appreciated that the first wavelength of light and the second wavelength of light can be other colors at other frequencies. In one illustrative embodiment, the first position and the second position can be determined by the location of the switch 54. In another illustrative embodiment, the first position and the second position can be determined as a function of the height of the occupant, which can be input through a user interface (not shown). It should be appreciated that the height of the occupant can be input from electronic medical records (EMR's). It should also be appreciated that the height of the occupant can be input through the PPM system. It should also be appreciated that the height of the occupant can be “learned” based on at least one of an average force profile over a period of time, user feedback, or other such techniques.

In operation, an occupant is supported on the upper frame 16 in a high position with respect to the floor. The height determining system 36 determines that the upper frame 16 is not in the low position and causes the height indicator 38 to emit amber light to indicate that the upper frame is not in the low position. In one illustrative embodiment, the occupant indicates through a user interface (not shown) that they desire the upper frame 16 to move from the first position to a second position so that they can egress from the person-support apparatus 10. In another illustrative embodiment, the occupant moves toward the edge of the upper frame 16 and/or the movement of the occupant on the upper frame 16 exceeds a predetermined threshold to indicate to the PPM system that the occupant desires the upper frame 16 to move from the first position to a second position so that they can egress from the person-support apparatus 10. The supports 14 move the upper frame 16 with respect to the lower frame 12 from the high position to the low position. Once the height determining system 36 determines that the upper frame 16 is in the low position, the height determining system 36 causes the height indicator 38 to emit green light to indicate the upper frame 16 is at the low height.

Many other embodiments of the present disclosure are also envisioned. For example, a person-support apparatus comprises a lower frame, a support, an upper frame and a plurality of light sources. The support couples to the lower frame. The upper frame is movably supported above the lower frame by the support. At least one of the plurality of light sources is configured to emit light at a first wavelength when the upper frame is in a first position with respect to the lower frame and at least one of the plurality of light sources is configured to emit light at a second wavelength when the upper frame is in a second position with respect to the lower frame. The plurality of light sources are not activated by a controller. It should be appreciated that the person-support apparatus can further comprise at least one switch coupled to the support. The at least one switch is configured to activate the light source when the upper frame is in a first position with respect to the lower frame and a second position with respect to the lower frame. It should be appreciated that the light source is activated by a switch coupled to at least one of the lower frame, the upper frame, and the support. It should also be appreciated that the support is fully extended and the upper frame is positioned at its maximum height with respect to the lower frame in the second position. It should also be appreciated that the support is fully retracted and the upper frame is positioned at its minimum height with respect to the lower frame in the first position. It should also be appreciated that the support is one of partially retracted and extended retracted and the upper frame is not positioned at one of its minimum height and maximum height with respect to the lower frame in the second position. It should also be appreciated that the upper frame includes a siderail coupled thereto. The light source is coupled to the siderail. It should also be appreciated that the upper frame includes a siderail with a user interface module coupled thereto. The light source is integrated into the user interface module. It should also be appreciated that the user interface module includes a housing with a first surface, a second surface, and a bottom surface extending between the first surface and the second surface. The first surface includes a user interface thereon. The light source is coupled to the bottom surface and configured to emit light in a downwardly direction toward the lower frame.

In another example, a person-support apparatus comprises a lower frame, a support, an upper frame and a light source. The support couples to the lower frame. The upper frame is movably supported above the lower frame by the support. The light source is configured to emit light at a first wavelength when the upper frame is in a first position with respect to the lower frame. The light source is activated by a switch coupled to at least one of the lower frame, the upper frame and the support. It should be appreciated that the light source is not activated by a controller. It should be appreciated that the light source is configured to emit light at a second wavelength when the upper frame is in a second position with respect to the lower frame. It should be appreciated that the support is fully extended and the upper frame is positioned at its maximum height with respect to the lower frame in the second position. It should be appreciated that the support is one of partially retracted and extended retracted and the upper frame is not positioned at one of its minimum height and maximum height with respect to the lower frame in the second position. It should be appreciated that the support is fully retracted and the upper frame is positioned at its minimum height with respect to the lower frame in the first position. It should be appreciated that the upper frame includes a siderail coupled thereto. The light source is coupled to the siderail. It should be appreciated that the upper frame includes a siderail with a user interface module coupled thereto. The light source is integrated into the user interface module. It should be appreciated that the user interface module includes a housing with a first surface, a second surface, and a bottom surface extending between the first surface and the second surface. The first surface includes a user interface thereon. The light source is coupled to the bottom surface and configured to emit light in a downwardly direction toward the lower frame.

In still another example, a kit for a person-support apparatus comprises a light source, a switch and a wire. The switch is configured to couple at least one of an upper frame, a lower frame, and a support supporting the upper frame above the lower frame. The wire is configured to couple with the switch and the light source.

In yet another example, a system for indicating the height of a person-support apparatus comprises a plurality of switches and a plurality of indicators. The plurality of switches is present on at least one of a lower frame, a support or an upper frame of the person-support apparatus. The plurality of switches configured to be operated as the person-support apparatus moves up/down. The plurality of indicators indicates the height of the person-support apparatus. The plurality of indicators being operated by the plurality of switches. It should be appreciated that the plurality of indicators are illumination sources of different color. It should be appreciated that the plurality of indicators are present on at least one of an upper frame, a siderail and a lower frame.

In yet another example, a system for indicating the height of a person-support apparatus comprises an indicator. The indicator is configured to emit light at one of a first color and a second color. The first color indicates the height of the person-support apparatus is safe for exit. The second color indicates the height of the person-support apparatus is low.

In yet another example, a person-support apparatus comprises a lower frame, a support, an upper frame and an illuminable indicator. The upper frame is supported on the support above the lower frame. The illuminable indicator is present on at least one of upper frame or the lower frame. The indicator faces a floor configured to provide information regarding height of the person-support apparatus with respect to the floor. The color of the illuminable indicator changes depending upon the height of the person-support apparatus.

In another example, a person-support apparatus comprises an illuminable indicator configured to provide information regarding the height of the person-support apparatus with respect to a floor. The color of the illuminable indicator changes depending upon the height of the person-support apparatus.

In another example, a person-support apparatus comprises a lower frame, a support, an upper frame, and a light source. The support is coupled to the lower frame. The upper frame is movably supported above the lower frame by the support. The light source is configured to selectively emit light at one of a first wavelength and a second wavelength as a function of the height of the upper frame with respect to a reference point in order to indicate the height of the upper frame.

In another example, a height indicating system for a person-support apparatus with an upper frame movably supported above a lower frame by a support comprises a height determining system and a light source. The height determining system is configured to determine the height of the upper frame with respect to a reference point. The light source is configured to illuminate a portion of a floor proximate to the light source with light at a first wavelength when the upper frame is at a first height and at a second wavelength when the upper frame is at a second height.

In another example, a night light for a person-support apparatus with a lower frame and an upper frame movably supported above the lower frame comprises a light source and a control system. The light source is configured to emit light at one of a first wavelength and a second wavelength. The control system is configured to determine the height of the upper frame with respect to a reference point. The control system is configured to cause the light source to emit light at the first frequency when the upper frame is at a first height and emit light at a second frequency when the upper frame is at a second height. The light source is configured to illuminate a portion of a floor when an amount of ambient light is below a predetermined threshold.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless can not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

What is claimed is:

1. A person-support apparatus, comprising:
a lower frame;
a support coupled to the lower frame;
an upper frame movably supported above the lower frame by the support; and
a light source configured to selectively emit light at one of a first wavelength and a second wavelength as a function of the height of the upper frame with respect to a reference point in order to indicate the height of the upper frame.

2. The person-support apparatus of claim 1, wherein the light source is configured to emit light at the first wavelength when the upper frame is at about its lowest height and at second wavelength with the upper frame is above its lowest height.

3. The person-support apparatus of claim 1, wherein the light source is configured to emit light at the first wavelength when the upper frame is at about a predetermined egress height and at a second wavelength when the upper frame is above the predetermined egress height.

4. The person-support apparatus of claim 3, wherein the predetermined egress height is a function of a height of an occupant supported on the upper frame.

5. The person-support apparatus of claim 1, wherein the light source operates independent of an alert system configured to alert a person to an unsatisfactory condition when the alert system is armed and an alert condition has been met.

6. The person-support apparatus of claim 1 further comprising a control system configured to automatically lower the upper frame to a predetermined egress height when the control system determines that an occupant egress condition has been met.

7. The person-support apparatus of claim 1 further comprising a user interface configured to receive an input from a user, the light source being configured to be activated and deactivated as a function of the input from the user interface.

8. A height indicating system for a person-support apparatus with an upper frame movably supported above a lower frame by a support, the height indicating system comprising:
a height determining system configured to determine the height of the upper frame with respect to a reference point; and
a light source configured to illuminate a portion of a floor proximate to the light source with light at a first wavelength when the upper frame is at a first height and at a second wavelength when the upper frame is at a second height.

9. The height indicating system of claim 8, wherein the light source is configured to emit light at the first wavelength when the upper frame is at its lowest height and at the second wavelength when the upper frame is above its lowest height.

10. The height indicating system of claim 8, wherein the light source is configured to emit light at the second wavelength when the upper frame is at a predetermined egress height and at a first wavelength when the upper frame is above the predetermined egress height.

11. The height indicating system of claim 10, wherein the predetermined egress height is a function of a height of an occupant supported on the upper frame.

12. The height indicating system of claim 8, wherein the light source emits amber colored light for the second wavelength and green colored light for the first wavelength.

13. The height indicating system of claim 8, wherein the height determining system includes a switch configured to be in a first state when the upper frame is at the first height and in a second state when the upper frame is at the second height, the light source being configured to selectively emit light at one of the first wavelength and the second wavelength as a function of the state of the switch.

14. The height indicating system of claim 8, wherein the height determining system includes a sensor configured to sense when an occupant's feet are on the floor, the light source being configured to emit light at the first wavelength when the sensor senses the occupant's feet on the floor and at the second wavelength when the sensor does not sense the occupant's feet on the floor.

15. The height indicating system of claim 8, wherein the height determining system includes a controller and a distance sensor configured to sense the distance between the upper frame and one of the floor and the lower frame, the controller being configured to cause the light source to emit light at the first wavelength when the upper frame is about a predetermined distance from the one of the lower frame and the floor and at the second wavelength when the upper frame is above the predetermined distance.

16. The height indicating system of claim 8, wherein the support is a lift mechanism with a lift controller, the lift controller causing the light source to emit light at the first wavelength when the lift mechanism is at about a predetermined position and at the second wavelength when the upper frame is not at the predetermined position.

17. The height indicating system of claim 8 further includes a user interface configured to receive an input from a user, the light source being configured to be activated and deactivated as a function of the input from the user interface.

18. The height indicating system of claim 17, wherein the support is a lift mechanism with a lift controller configured to control the operation of the lift driver, the lift controller being configured to determine the height of the upper frame with respect to the reference point as a function of an amount of actuation of the lift driver and cause the light source to emit light at the first wavelength when the upper frame is at a first height and at the second wavelength when the upper frame is at a second height.

19. The height indicating system of claim 8, wherein the light source emits light in the visible light spectrum.

20. The height indicating system of claim 8, wherein the light source emits ultraviolet light.

21. A night light for a person-support apparatus with a lower frame and an upper frame movably supported above the lower frame, the night light comprising:
a light source configured to emit light at one of a first wavelength and a second wavelength; and
a control system configured to determine the height of the upper frame with respect to a reference point, the control system being configured to cause the light source to emit light at the first frequency when the upper frame is at a first height and emit light at a second frequency when the upper frame is at a second height, the light source being configured to illuminate a portion of a floor when an amount of ambient light is below a predetermined threshold.
